(19) United States
(12) Patent Application Publication
(10) Pub. No.: US 2019/0013129 A1
(43) Pub. Date: Jan. 10, 2019

(54) DUST CORE

(71) Applicant: Panasonic Intellectual Property Management Co., Ltd., Osaka (JP)

(72) Inventors: MASATO MAEDE, Kyoto (JP); TOSHIYUKI KOJIMA, Kyoto (JP)

(21) Appl. No.: 16/026,035

(22) Filed: Jul. 2, 2018

(30) Foreign Application Priority Data
Jul. 6, 2017 (JP) 2017-132410
Jul. 25, 2017 (JP) 2017-143359
Apr. 27, 2018 (JP) 2018-085902

(51) Int. Cl. H01F 3/08; H01F 41/02; B22F 1/00

(52) U.S. Cl. CPC H01F 3/08; H01F 41/0246; H01F 1/15308; B22F 1/0014; B22F 2999/00; H01F 41/0226

(57) ABSTRACT

A dust core capable of reducing the eddy-current loss of a soft magnetic powder, and having a small loss, particularly in a high-frequency region includes a powder of a soft magnetic composition having a maximum roundness of 0.5 or more, and a mean roundness of 0.2 or more. The powder includes a pulverized powder and a spherical powder. The pulverized powder has a maximum roundness of 0.5 or more, and a mean roundness of 0.2 or more. The spherical powder has a maximum roundness of 0.9 or more, and a mean roundness of 0.5 or more.

### TECHNICAL FIELD

The technical field relates to a dust core using a magnetic powder, particularly, a dust core using a soft magnetic powder used in inductor applications such as in choke coils, reactors, and transformers.

### BACKGROUND

There is a growing demand for the development of electrically powered automobiles, and lighter vehicles. This has created a demand for making various electronic components smaller and lighter, and there is an increasing demand for higher performance in soft magnetic powders and in dust cores using soft magnetic powders in applications such as in choke coils, reactors, and transformers.

For miniaturization and lightness, the materials used for dust cores using soft magnetic powders require a high saturation flux density and a small core loss. Dust cores using soft magnetic powders also require desirable DC bias characteristics.

For example, Japanese Patent Number 4944971 describes a method that uses a pulverized powder of an Fe-based amorphous alloy having a small core loss and desirable DC bias characteristics.

### SUMMARY

FIGS. 1A and 1B show pulverized powders of an Fe-based amorphous alloy ribbon described in Japanese Patent Number 4944971. The powders are produced by pulverizing a ribbon.

FIG. 1A shows a first powder 1 having a particle size of 50 or more. FIG. 1B shows a second powder 2 having a particle size of 50 μm or less.

The foregoing patent describes a dust core in which a pulverized powder produced by pulverizing an Fe-based amorphous alloy ribbon is contained as a main component, together with another main component—an atomized Fe-based amorphous alloy spherical powder. The first powder 1, which is a pulverized powder having a particle size at least two times greater and no greater than 6 times the thickness of the Fe-based amorphous alloy ribbon (thickness=25 μm; the particle size is at least 25 μm×2=50 μm, and no greater than 25 μm×6=150 μm), is 80 mass % or more of the total pulverized powder. The second powder 2, which has a particle size no greater than 2 times the ribbon thickness (thickness=25 μm; the particle size is no greater than 25 μm×2=50 μm), is 20 mass % or less of the total pulverized powder. Here, the particle size of the pulverized powder is the minimum value as measured in a plane direction on the principal surface of the sheet-like pulverized powder.

The atomized spherical powder has a particle size that is no greater than half the ribbon thickness (thickness=25 μm; the particle size is no greater than 25 μm×½=12.5 μm), and is 3 μm or more.

However, in the foregoing patent, the electrical resistance of the first powder 1 itself is small because of the large fraction of the first powder 1 having a particle size at least two times the ribbon thickness (the particle size is 50 μm or more). At high frequencies (for example, 100 kHz or more), the eddy current increases, and a considerably large eddy-current loss occurs. This increases the loss in a dust core using the powder.

The present disclosure is intended to provide a solution to the foregoing problem of the related art, and enables reducing the eddy-current loss of a soft magnetic powder, particularly in a high-frequency region. The present disclosure is also intended to provide a dust core that can exhibit a high saturation flux density and desirable soft magnetic characteristics.

According to an aspect of the disclosure, there is provided a dust core comprising a powder of a soft magnetic composition, wherein the powder has a maximum roundness of 0.5 or more, and a mean roundness of 0.2 or more.

According to another aspect of the disclosure, there is provided a dust core comprising a powder of a soft magnetic composition, wherein the powder includes a pulverized powder and a spherical powder, the pulverized powder having a maximum roundness of 0.5 or more, and a mean roundness of 0.2 or more, the spherical powder having a maximum roundness of 0.9 or more, and a mean roundness of 0.5 or more.

The means disclosed in the embodiments enable reducing the eddy-current loss of a soft magnetic powder, particularly in a high-frequency region. A dust core that can exhibit a high saturation flux density and desirable soft magnetic characteristics also can be provided.

### BRIEF DESCRIPTION OF THE DRAWINGS

FIG. 1A is a diagram showing a soft magnetic powder having a particle size of 50 μm or more described in Japanese Patent Number 4944971. FIG. 1B is a diagram showing a soft magnetic powder having a particle size of 50 μm or less described in Japanese Patent Number 4944971.

FIGS. 2A and 2B are diagrams representing the steps of producing a soft magnetic powder of First Embodiment.

FIG. 3A is an SEM showing a soft magnetic powder of Example 1.

FIG. 3B shows an image magnifying region A of FIG. 2A.

FIG. 4 is a diagram showing particle size distributions of soft magnetic powders according to First Embodiment.

FIG. 5A is an SEM showing a cross section of a dust core using the soft magnetic powder of First Embodiment. FIG. 5B shows an image magnifying region B of FIG. 5A.

FIG. 6 is a diagram showing a roundness distribution of a soft magnetic powder contained in the dust core of First Embodiment.

FIG. 7 is a diagram showing a maximum length distribution of a soft magnetic powder contained in the dust core of First Embodiment.

FIG. 8 is a cross sectional view of a dust core using a soft magnetic powder as a mixture of a pulverized powder and a spherical powder according to Second Embodiment.

FIGS. 9A and 9B are diagrams representing the steps of producing a soft magnetic pulverized powder of Second Embodiment.

FIG. 10A is an SEM showing a soft magnetic pulverized powder of Second Embodiment. FIG. 10B shows an image magnifying region A of FIG. 10A.

FIG. 11 is a diagram showing a particle size distribution of the soft magnetic pulverized powder of Second Embodiment.

FIG. 12 is a diagram showing a maximum length distribution of a soft magnetic pulverized powder contained in the dust core of Second Embodiment.

FIG. 13 is a cross sectional view of a dust core using a soft magnetic powder as a mixture of a pulverized powder and a spherical powder according to Third Embodiment.

FIG. 14 is a cross sectional view of a dust core using a soft magnetic powder as a mixture of a pulverized powder and a spherical powder according to Fourth Embodiment.

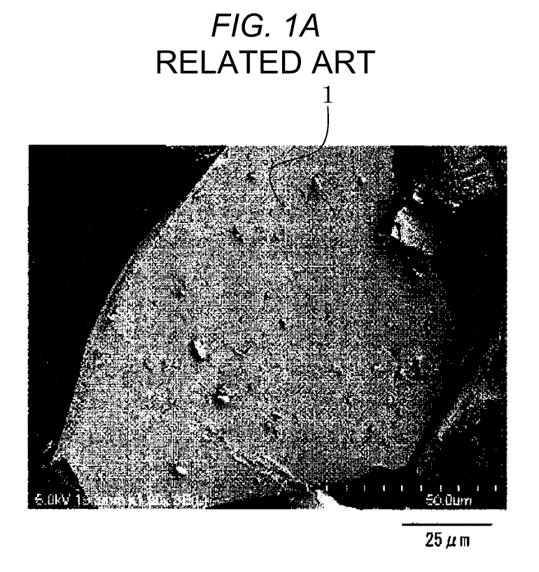

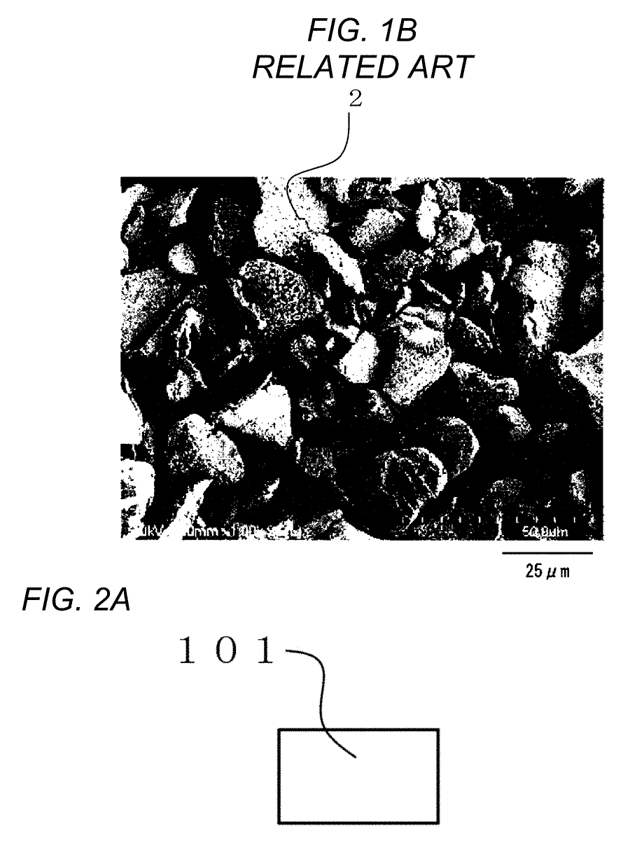

### DESCRIPTION OF EMBODIMENTS

### First Embodiment

### Production of Soft Magnetic Powder

A method for producing a soft Magnetic Powder of First Embodiment is described first.

(1) An alloy composition is melted by means of, for example, high-frequency heating, and an amorphous-phase ribbon or sheet is produced by liquid quenching. A single-roll or twin-roll amorphous manufacturing apparatus used for manufacture of, for example, Fe-based amorphous ribbons may be used for the liquid quenching.

(2) The ribbon or sheet is pulverized into a powder. The ribbon or sheet may be pulverized using a common pulverizer. For example, a ball mill, a stamping mill, a planetary mill, a cyclone mill, a jet mill, or a rotary mill may be used.

Here, the ribbon becomes brittle, and easily pulverizes when it is heated to crystallize. However, this increases the hardness of the ribbon, and the ribbon cannot be easily pulverized into a small powder, with the result that the fraction of a second powder 2 of a small particle size decreases. In the embodiment, the ribbon is therefore pulverized without heating so that the ribbon does not increase its hardness, and can be pulverized into a small powder, making it possible to increase the fraction of the second powder 2 of a small particle size.

After pulverization, the powder is classified with a sieve, and a soft magnetic powder having a desired particle size distribution is obtained.

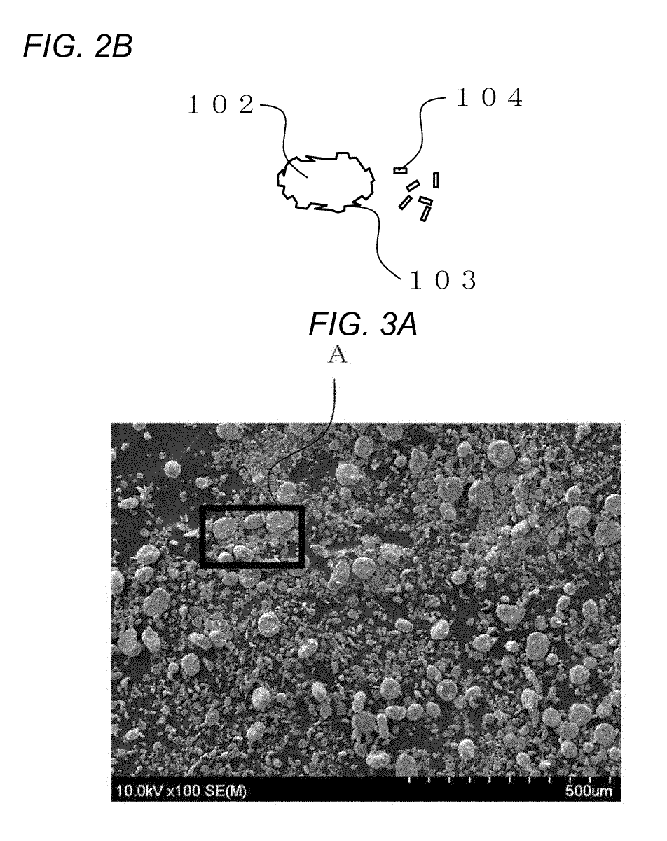

The following describes the mechanism by which the pulverized powder of the present embodiment is produced, with reference to FIGS. 2A and 2B. The soft magnetic ribbon 101 shown in FIG. 2A is pulverized using a rotary mill or the like. As a result, the surface of a powder 102 cleaves as illustrated in FIG. 2B, chipping away fine powders 104, and producing a powder 102 with a surface having a pulverization mark 103. By being cleaved at the surface, the powder 102 has a round shape with no angles. The surface of the fine powder 104 also cleaves by the same mechanism, the fine powder 104 also has a round shape with no angles.

(3) The powder 102 and the fine powder 104 are subjected to a heat treatment to remove the internal strain due to pulverization, and to precipitate an αFe crystal phase. A heat-treatment device such as, for example, a hot-air furnace, a hot press, a lamp, a metal sheathed heater, a ceramic heater, and a rotary kiln may be used. Here, it is preferable to rapidly apply heat, using a hot press or the like. This further promotes crystallization of the powder 102 and the fine powder 104, and the surface cleaving of the powder 102 accelerates. In this way, the second powder 2 of a small particle size can increase its fraction.

Production of Dust Core

(1) For the production of a dust core of First Embodiment, the soft magnetic powder 102 and the fine powder 104 are mixed with a binder having desirable insulation and high heat resistance, such as a phenolic resin and a silicone resin, to produce a granulated powder.

(2) The granulated powder is charged into a mold of the desired shape having high heat resistance, and molded under applied pressure to obtain a compact.

(3) Heating at a temperature that cures the binder produces a dust core having a small loss in a high-frequency region.

### Example 1

An Fe-based amorphous alloy ribbon of the composition Fe73.5-Cu1-Nb3-Si13.5-B9 (atomic %) prepared by single-roll quenching was pulverized using a rotary mill, and an amorphous-phase soft magnetic alloy powder was obtained. The pulverization consisted of 3 minutes of coarse pulverization, 20 minutes of normal fine pulverization, and 20 minutes of cooled pulverization.

The soft magnetic alloy powder was subjected to a heat treatment to remove the internal strain due to pulverization, and to precipitate an αFe crystalline phase. The heat treatment was performed at 550° C. with a hot press for 20 seconds.

The soft magnetic alloy powder was then mixed with a silicone resin used as a binder, and granulated into a granulated powder. The granulated powder was transferred into a mold, and molded under an applied pressure of 4 ton/cm² to produce a compact, using a press. The silicone resin was used in about 3 weight % of the soft magnetic powder.

### Evaluation of Core Loss (Core Loss)

The compacts were measured for core loss at a frequency of 1 MHz and a magnetic flux density of 25 mT, using a B-H analyzer. Samples with a core loss of 1,300 kW/m³ or less were determined as being desirable. This is to ensure that the core loss value is no greater than the core loss values of common metallic materials. The core loss of the compact of Example 1 measured with a B-H analyzer was 1,040 kW/m³, and passed the test. It was indeed possible to obtain a dust core having a small loss in a high-frequency region.

### Powder Shape

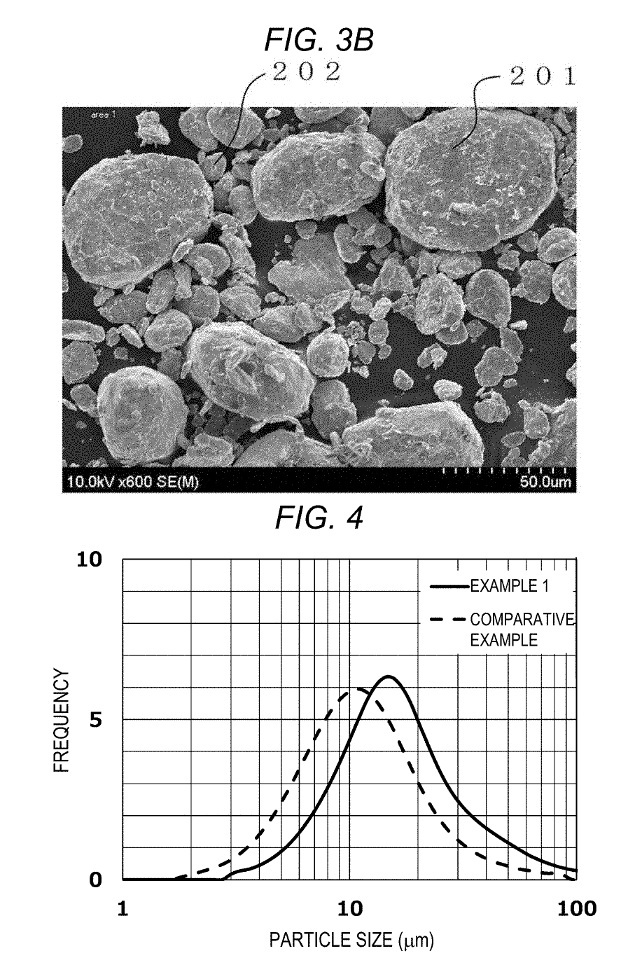

FIG. 3A shows an SEM of the soft magnetic powder of Example 1. FIG. 3B shows an image magnifying region A of FIG. 3A. The powder 201 corresponds to powder 102, and the powder 202 corresponds to fine powder 104. Because the powder 201 and the powder 202 are produced by the pulverization of the mechanism described above, these are rounded in shape with no angles.

### First Powder 1 and Second Powder 2

The first powder 1, which had a particle size of more than 32 μm, was 30 weight % or less of the total pulverized powder. The second powder 2, which had a particle size of 32 μm or less, was 70 weight % or more of the total pulverized powder. At least one of the first powder 1 and the second powder 2 needs to be present. Here and below, the particle size was determined bypassing the powder through a 32-μm opening.

The particle size distribution showed that a certain quantity of first powder 1 was present, and that the second powder 2 was abundant, as shown in FIG. 3A.

FIG. 4 shows particle size distributions of soft magnetic powders of Example 1 and Comparative Example. In Comparative Example, the pulverization time is longer than in Example 1. The manufacturing conditions will be described in conjunction with the magnetic permeability described below. The particle size distribution was measured with a Microtrack MT3000 (2) Series. In FIG. 4, the horizontal axis represents particle size, and the vertical axis represents the frequency of soft magnetic powders of different particle sizes. In Example 1, D10% was 7 μm, D50% was approximately 14.6 μm, and D90% was 37.7 μm in a cumulative distribution.

### Dust Core

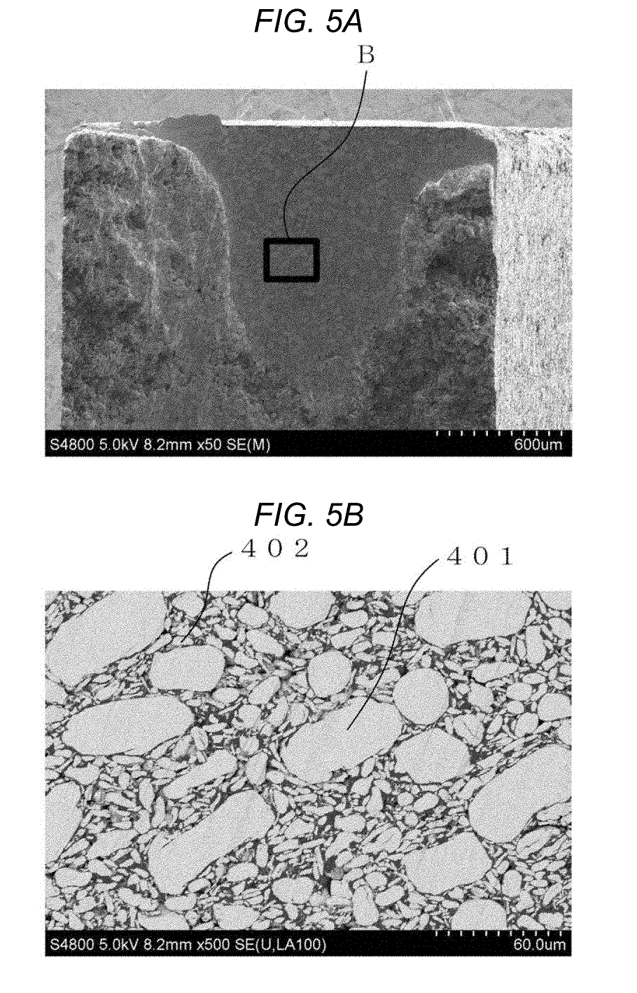

FIG. 5A is a SEM showing a cross section of a dust core of Example 1. FIG. 5B shows an image magnifying region B of FIG. 5A. The powder 401 corresponds to powder 102. The powder 402 corresponds to fine powder 104. Because the powder 401 is produced by the pulverization of the foregoing mechanism, the powder 401 has a shorter side about the same as the thickness of the starting material soft magnetic ribbon.

### Roundness Distribution

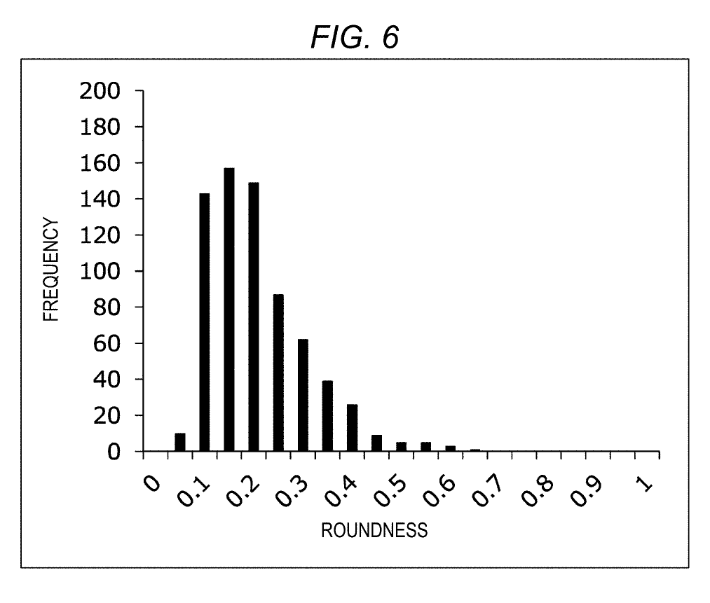

FIG. 6 represents a roundness distribution of the powder of Example 1. The roundness distribution was calculated using a WinRoof. In FIG. 6, the horizontal axis represents roundness, and the vertical axis represents the frequency of soft magnetic powders of different roundnesses.

The maximum roundness may be 0.5 or more, and the mean roundness may be 0.2 or more. The maximum roundness is preferably 0.7 or more, and the mean roundness is preferably 0.3 or more. The maximum roundness is more preferably 0.8 or more, and the mean roundness is more preferably 0.4 or more.

With increased roundness values, the soft magnetic powder can be charged into a mold with more fluidity in dust core production, and the porosity of the dust core can decrease. Reducing the porosity increases the fraction of the soft magnetic powder per unit volume, and the soft magnetic characteristics of the dust core, including saturation flux density, and magnetic permeability, can improve.

### Maximum Length of Powder

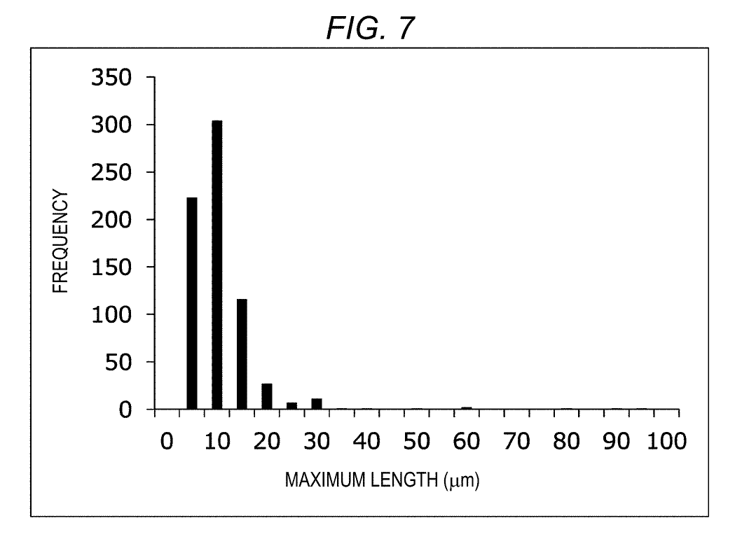

FIG. 7 represents the maximum length (the longest part of a powder) of the powder of Example 1. The maximum length distribution was calculated with a WinRoof. In FIG. 7, the horizontal axis represents maximum length, and the vertical axis represents the frequency of soft magnetic powders of different maximum lengths.

The maximum value of maximum lengths may be 50 μm or more and 100 μm or less. The minimum value of maximum lengths may be 5 μm or less. The mean value of maximum lengths may be 6 μm or more and 9 μm or less.

The maximum value of maximum lengths is preferably 50 μm or more and 80 μm or less. The minimum value of maximum lengths is preferably 0.5 μm or less. The mean value of maximum lengths is preferably 5 μm or more and 9 μm or less.

The maximum value of maximum lengths is more preferably 50 μm or more and 60 μm or less.

With a smaller maximum length, the particle size of the soft magnetic powder decreases, and the electrical resistance of the soft magnetic powder can increase. This makes it possible to reduce the eddy current at high frequency (for example, 100 kHz or more), and the eddy-current loss can decrease. A dust core using the soft magnetic powder can have a smaller loss accordingly.

### Porosity

The porosity of the dust core of Example 1 was calculated by image analysis. The dust core of Example 1 had a porosity of 26.8%.

The porosity of the dust core (portions other than the soft magnetic powder) may be 30% or less, or 20% or less. Preferably, the porosity of the dust core is 10% or less.

With a smaller porosity, the fraction of the soft magnetic powder per unit volume increases, and the soft magnetic characteristics of the dust core, including saturation flux density, and magnetic permeability, can improve.

### Particle Size and Oxygen Content

The total oxygen content of the soft magnetic powder is measured as follows. First, only a graphite crucible is heated in an inert gas atmosphere (e.g., helium), and the soft magnetic powder is heated to a temperature that melts the soft magnetic powder. In response, the oxygen in the soft magnetic powder reacts with the graphite to form carbon monoxide. Because carbon monoxide actively absorbs infrared rays, it can be detected by an infrared absorption method.

The measured total oxygen content for the powder of Example 1 was 1.01%. The total oxygen content of the first powder 1 is preferably 0.8 weight % or less, and the total oxygen content of the second powder 2 is preferably 1.7 weight % or less.

More preferably, the total oxygen content of the first powder 1 is 0.4 weight % or less, and the total oxygen content of the second powder 2 is 0.8 weight % or less.

Further preferably, the total oxygen content of the first powder 1 is 0.2 weight % or less, and the total oxygen content of the second powder 2 is 0.4 weight % or less.

With a smaller oxygen content, the fraction of oxidized soft magnetic powders becomes smaller, and a larger fraction of the soft magnetic powders shows desirable soft magnetic characteristics. This makes it possible to improve the soft magnetic characteristics of the dust core, including saturation flux density, and magnetic permeability. The loss also can be reduced.

### Effects

The powder produced by pulverization by way of cleaving of a powder surface has a round shape with no angles, and can be easily controlled to create a particle size distribution of first powder 1, and a large amount of second powder 2. The powder can easily cleave at the time of pulverization when it is not subjected to an embrittlement heat treatment before pulverization. When subjected to a heat treatment for embrittlement, the hardness of the ribbon increases, and pulverization becomes difficult. That is, cleaving does not easily take place.

The pulverization thus enables the soft magnetic powder to be transferred into a mold with more fluidity in dust core production, and the second powder 2 can more easily enter between the first powders 1. In this way, the dust core can have a smaller porosity. By reducing porosity, the fraction of soft magnetic powder per unit volume increases, and the soft magnetic characteristics of the dust core, including saturation flux density, and magnetic permeability, can improve.

Because the first powder 1 is 30 weight % or less of the total pulverized powder, and the second powder 2 is 70 weight % or more of the total pulverized powder, the electrical resistance of the pulverized powder increases, and the eddy-current can be reduced at high frequency (for example, 100 kHz or more), and the eddy-current loss can decrease. A dust core using the soft magnetic powder can have a smaller loss accordingly.

### Magnetic Permeability

The magnetic permeability of the dust core was examined.

### Evaluation of Core Loss (Magnetic Permeability)

The compacts of different samples were measured for magnetic permeability at 100 kHz frequency using an impedance analyzer. Samples with a magnetic permeability of 22 or more were determined as being desirable. This is to ensure that the magnetic permeability is no smaller than the magnetic permeability of similar metallic materials. The samples of Example 1 were measured with an impedance analyzer. The samples of Example 1 had a magnetic permeability of 24.0, and cleared the test. It was indeed possible to obtain a dust core having desirable magnetic characteristics.

### Example 1

Samples were produced under the conditions above. The normal fine pulverization is a total of 20 minutes and the cooling time is a total of 20 minutes. During the course of cooling time, the motor of the pulverizer, and the pulverization vessel were cooled with a spot cooler. The temperature was maintained, on average, at 65° C. by cooling. A cycle consisting of 2.5 minutes of normal pulverization, and 2.5 minutes of cooling time was repeated eight times.

### Comparative Example

Fine pulverization was performed for a total of 60 minutes. The pulverization time is 20 minutes for normal fine pulverization, and 50 minutes for cooled pulverization. Other conditions are the same as in Example 1. The temperature was, on average, 80° C. A cycle consisting of 1 minute of normal pulverization, and 2 minutes of cooled pulverization was repeated twenty times.

Example 1 and Comparative Example are different with respect to pulverization time. The particle size is larger, and the magnetic permeability is higher in Example 1 in which the total pulverization time is shorter. The magnetic characteristics are accordingly more desirable in Example 1. The particle size decreases as the pulverization time increases. With a smaller particle size, the fraction of the oxide layer with respect to the volume occupied by the particles increases, and the magnetic permeability is low.

It is therefore preferable that the particle size d50% be larger than 10.7 μm, preferably 13 to 17 μm.

TABLE 1

| | Total fine | | | Magnetic |
|---|---|---|---|---|
| | pulverization | Particle size | Core loss of | permeability of |
| | time | (μm) | compact | compact |
| | (min) | (d50%) | (kW/m³) | (kW/m³) |
| Example 1 | 40 | 14.6 | 1,040 | 24.0 |
| Comparative | 60 | 10.7 | 1,060 | 19.9 |
| Example | | | | |

### Second Embodiment

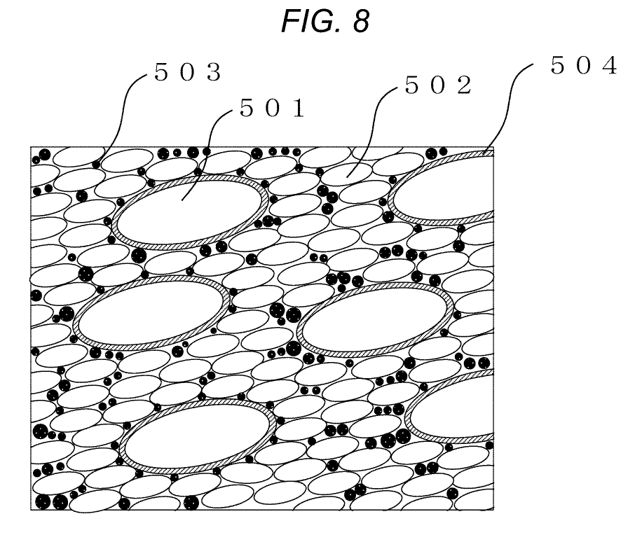

FIG. 8 shows a cross section of a dust core using a soft magnetic powder as a mixture of a pulverized powder and a spherical powder according to Second Embodiment of the present disclosure. The first powder 501 and the second powder 502 represent the pulverized powder. The spherical powder 503 represents the spherical powder.

The first powder 501 is a pulverized powder having a particle size of more than 32 μm, and is 30 weight % or less of the total pulverized powder. The second powder 502 is a pulverized powder having a particle size of 32 μm or less, and is 70 weight % or more of the total pulverized powder.

The spherical powder 503 has a particle size with a cumulative distribution D50% of 9 μm or less, and occupies 1 to 30 volume % of the dust core.

Formed on the surface of the first powder 501 is an insulating film 504 of high electrical resistance. The insulating film 504 is thicker than a natural oxide film (10 nm to 20 nm). The insulating film 504 forms an oxide film of, for example, FeO, Fe₂O₃, Fe₃O₄, Al₂O₃, and SiO₂, as a result of a heat treatment whereby the constituting elements of the first powder 501 bind to the oxygen in the atmosphere. Alternatively, a chemical technique or a physical technique is used to form an insulating film of, for example, SiO₂, Al₂O₃, and TiO₂.

The following describes a method for producing the dust core of Second Embodiment.

### Production of First Powder 501 and Second Powder 502

### Production of Pulverized Powder

(1) An alloy composition is melted by means of, for example, high-frequency heating, and an amorphous-phase ribbon or sheet is produced by liquid quenching. A single-roll or twin-roll amorphous manufacturing apparatus used for manufacture of, for example, Fe-based amorphous ribbons may be used for the liquid quenching that produces the amorphous-phase ribbon.

(2) The ribbon or sheet is pulverized into a powder. The ribbon or sheet may be pulverized using a common pulverizer. For example, a ball mill, a stamping mill, a planetary mill, a cyclone mill, a jet mill, or a rotary mill may be used.

Here, the ribbon becomes brittle, and easily pulverizes when it is heated to crystallize. However, it increases the hardness of the ribbon, and the ribbon cannot be easily pulverized into a small powder, with the result that the fraction of pulverized powders of a small particle size decreases. In the embodiment, the ribbon is therefore pulverized without heating so that the ribbon does not increase its hardness, and can be pulverized into a small powder, making it possible to increase the fraction of pulverized powders of a small particle size.

After pulverization, the powder is classified with a sieve, and a soft magnetic pulverized powder having a desired particle size distribution is obtained.

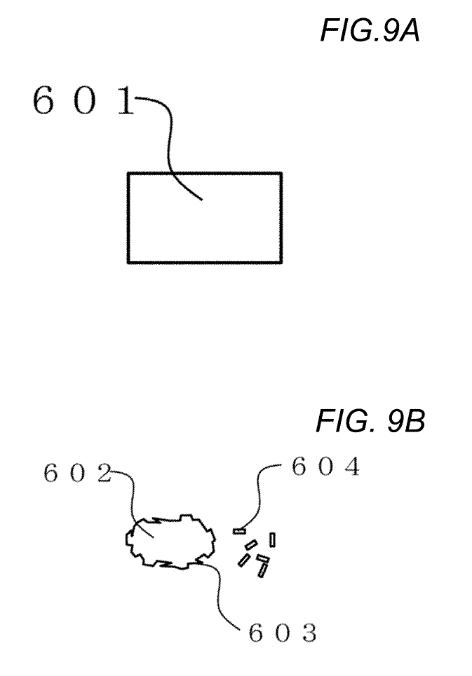

The following describes the mechanism by which the pulverized powder of the present embodiment is produced, with reference to FIGS. 9A and 9B. The soft magnetic ribbon 601 shown in FIG. 9A is pulverized using a rotary mill or the like. As a result, the surface of a powder 602 cleaves as illustrated in FIG. 9B, chipping away fine powders 604, and producing a powder 602 having a surface with a pulverization mark 603. By being cleaved at the surface, the powder 602 has a round shape with no angles. The surface of the fine powder 604 also cleaves by the same mechanism, the fine powder 604 also has a round shape with no angles. Here, the powder 602 corresponds to the first powder 501, and the fine powder 604 corresponds to the second powder 502.

(3) The pulverized powder (powder) of the ribbon or sheet is subjected to a heat treatment to remove the internal strain due to pulverization, and to precipitate an αFe crystal phase. A heat-treatment device such as, for example, a hot-air furnace, a hot press, a lamp, a metal sheathed heater, a ceramic heater, and a rotary kiln may be used. Here, it is preferable to rapidly apply heat, using a hot press or the like. This further promotes crystallization, and the surface cleaving of the powder 602 accelerates. In this way, the pulverized powder of a small particle size can increase its fraction.

### Production of Spherical Powder 503

For the production of the spherical powder, an amorphous-phase powder is produced by using a method such as gas atomization, and water atomization. The powder is then subjected to a heat treatment to remove internal strain, and to precipitate an αFe crystalline phase.

Alternatively, the surface of the pulverized powder produced in the manner described above may be mechanically ground into a spherical shape, or the pulverized powder may be remelted with a thermal plasma to produce the spherical powder.

### Mixing of Pulverized Powder and Spherical Powder 503, and Production of Dust Core

(1) For the production of the dust core of Second Embodiment, the first powder 501, the second powder 502, and the spherical powder 503 are mixed with a binder having desirable insulation and high heat resistance, such as a phenolic resin and a silicone resin, to produce a granulated powder, using a mixer. Here, the mixture of the pulverized powder and the spherical powder 503 represents the soft magnetic powder.

(2) The granulated powder is charged into a mold of the desired shape having high heat resistance, and molded under applied pressure to obtain a compact.

(3) Heating at a temperature that cures the binder produces a dust core having a small loss in a high-frequency region.

### Example 2

An Fe-based amorphous alloy ribbon of the composition Fe73.5-Cu1-Nb3-Si13.5-B9 (atomic %) prepared by single-roll quenching was pulverized using a rotary mill, and an amorphous-phase soft magnetic pulverized powder was obtained. The pulverization consisted of 3 minutes of coarse pulverization, and 40 minutes of fine pulverization.

The Fe—Si—Cr—B (particle size 5 μm) available from Epson Atmix Corporation was used as the spherical powder 503.

The pulverized powder was subjected to a heat treatment to remove the internal strain due to pulverization, and to precipitate an αFe crystalline phase. The heat treatment was performed at 550° C. with a hot press for 20 seconds.

The soft magnetic powder as a mixture of the pulverized powder and the spherical powder 503 was then mixed with silicone resin used as a binder, and granulated into a granulated powder.

The granulated powder was transferred into a mold, and molded under an applied pressure of 4 ton/cm² to produce a compact, using a press. The soft magnetic powder as a mixture of the pulverized powder and the spherical powder 503 contained the pulverized powder and the spherical powder 503 in a 9:1 ratio (weight ratio). The silicone resin was used in about 3 weight % of the soft magnetic powder as a mixture of the pulverized powder and the spherical powder 503.

The compacts were measured for core loss at a frequency of 1 MHz and a magnetic flux density of 25 mT, using a B-H analyzer. Samples with a core loss of 1,300 kW/m³ or less were determined as being desirable. This is to ensure that the core loss value is no greater than the core loss values of common metallic materials. It was indeed possible to obtain a dust core having a small loss in a high-frequency region.

### Shape of Pulverized Powder

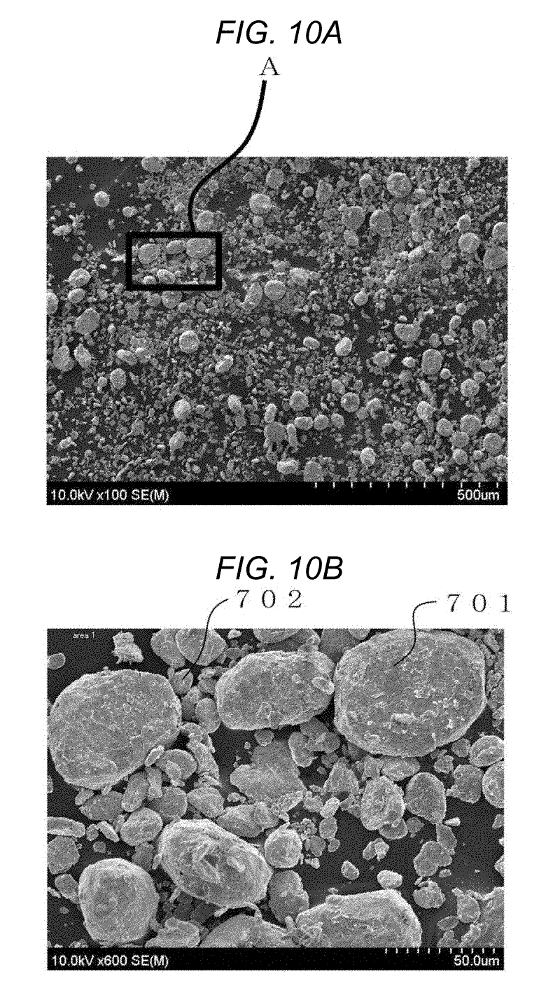

FIG. 10A shows an SEM of the soft magnetic pulverized powder of Example 2. FIG. 10B shows an image magnifying region A of FIG. 10A. The first powder 701 is the powder 602 of FIG. 9B, and the second powder 702 is the fine powder 604 of FIG. 9B. The first powder 701 and the second powder 702 are produced by the pulverization of the mechanism described above, and these are rounded in shape with no angles.

Pulverized Powder with Particle Size of 32 μm or More

The first powder 701 is a pulverized powder having a particle size of more than 32 μm. The first powder 701 was 30 weight % or less of the total pulverized powder. The second powder 702 is a pulverized powder having a particle size of 32 μm or less. The second powder 702 was 70 weight % or more of the total pulverized powder. At least one of the first powder 701 and the second powder 702 needs to be present. Here and below, the particle size was determined by passing the powder through a 32-μm opening.

The particle size distribution showed that a certain quantity of first powder 701 was present, and that the second powder 702 was abundant, as shown in FIG. 10A.

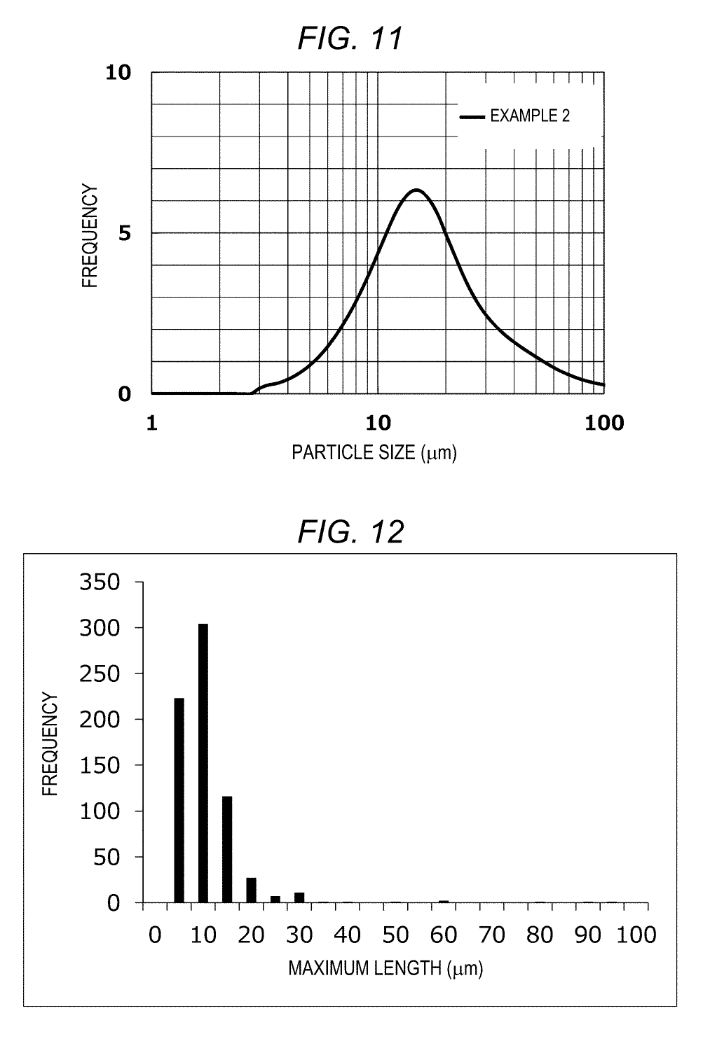

FIG. 11 shows a particle size distribution of the soft magnetic pulverized powder of Example 2. The particle size distribution was measured with a Microtrack MT3000 (2) Series. In FIG. 11, the horizontal axis represents particle size, and the vertical axis represents the frequency of soft magnetic pulverized powders of different particle sizes. D10% was 7 μm, D50% was 14.6 μm, and D90% was 37.7 μm in a cumulative distribution.

### Roundness of Pulverized Powder and Spherical Powder 503

The roundness distribution of pulverized powder was calculated using a WinRoof.

The pulverized powder of Example 2 had a maximum roundness of 0.79, and a mean roundness of 0.31. The maximum roundness of the pulverized powder may be 0.5 or more, and the mean roundness of the pulverized powder may be 0.2 or more. The maximum roundness of the pulverized powder is preferably 0.7 or more, and the mean roundness of the pulverized powder is preferably 0.3 or more. More preferably, the maximum roundness of the pulverized powder is 0.8 or more, and the mean roundness of the pulverized powder is 0.4 or more.

The spherical powder 503 of Example 2 had a maximum roundness of 0.95, and a mean roundness of 0.6. The maximum roundness of the spherical powder 503 is preferably 0.9 or more, and the mean roundness of the spherical powder 503 is preferably 0.5 or more.

With increased roundness values, the soft magnetic powder can be charged into a mold with more fluidity in dust core production, and the porosity of the dust core can decrease. Reducing the porosity increases the fraction of the soft magnetic powder per unit volume, and the soft magnetic characteristics of the dust core, including saturation flux density, and magnetic permeability, can improve.

### Maximum Length of Pulverized Powder

FIG. 12 represents the maximum length (the longest part of a powder) of the pulverized powder. The maximum length distribution of the pulverized powder was calculated with a WinRoof. In FIG. 12, the horizontal axis represents maximum length, and the vertical axis represents the frequency of soft magnetic pulverized powders of different maximum lengths.

The maximum value of maximum lengths may be 50 μm or more and 100 μm or less. The minimum value of maximum lengths may be 5 μm or less. The mean value of maximum lengths may be 6 μm or more and 9 μm or less.

The maximum value of maximum lengths is preferably 50 μm or more and 80 μm or less. The minimum value of maximum lengths is preferably 0.5 μm or less. The mean value of maximum lengths is preferably 5 μm or more and 9 μm or less.

The maximum value of maximum lengths is more preferably 50 μm or more and 60 μm or less.

With a smaller maximum length, the particle size of the soft magnetic pulverized powder decreases, and the electrical resistance of the soft magnetic pulverized powder can increase. This makes it possible to reduce the eddy current at high frequency (for example, 100 kHz or more), and the eddy-current loss can decrease. A dust core using the soft magnetic pulverized powder can have a smaller loss accordingly.

### Oxygen Content of Pulverized Powder

The total oxygen content of the soft magnetic pulverized powder is measured as follows. First, only a graphite crucible is heated in an inert gas atmosphere (e.g., helium), and the soft magnetic pulverized powder is heated to a temperature that melts the soft magnetic pulverized powder. In response, the oxygen in the soft magnetic pulverized powder reacts with the graphite to form carbon monoxide. Because carbon monoxide actively absorbs infrared rays, it can be detected by an infrared absorption method.

The total oxygen content of the pulverized powder of Example 2 was 1.01%.

The total oxygen content of the first powder 701 is preferably 0.8 weight % or less, and the total oxygen content of the second powder 702 is preferably 1.7 weight % or less.

The total oxygen content of the first powder 701 is preferably 0.4 weight % or less, and the total oxygen content of the second powder 702 is preferably 0.8 weight % or less.

Further preferably, the total oxygen content of the first powder 701 is 0.2 weight % or less, and the total oxygen content of the second powder 702 is 0.4 weight % or less.

With a smaller oxygen content, the fraction of oxidized soft magnetic pulverized powders becomes smaller, and a larger fraction of the soft magnetic pulverized powders shows desirable soft magnetic characteristics. This makes it possible to improve the soft magnetic characteristics of the dust core, including saturation flux density, and magnetic permeability. The loss also can be reduced.

### Effects

The pulverized powder produced by way of cleaving of a powder surface has a round shape with no angles, and can be easily controlled to create a particle size distribution of first powder 701, and a large amount of second powder 702.

This enables the soft magnetic pulverized powder to be transferred into a mold with more fluidity in dust core production, and the second powder 702 can more easily enter between the first powders 701.

By mixing the spherical powder 503 (a spherical powder with a particle-size cumulative distribution D50% of 9 μm or less), the space between the first powder 701 and the second powder 702 can be filled with the spherical powder 503. In this way, the dust core can have a smaller porosity. By reducing porosity, the fraction of the soft magnetic powder as a mixture of the pulverized powder and the spherical powder 503 per unit volume increases, and the soft magnetic characteristics of the dust core, including saturation flux density, and magnetic permeability, can improve.

Because the first powder 701 is 30 weight % or less of the total pulverized powder, and the second powder 702 is 70 weight % or more of the total pulverized powder, the electrical resistance of the pulverized powder increases, and the eddy-current can be reduced at high frequency (for example, 100 kHz or more), and the eddy-current loss can decrease. A dust core using the soft magnetic powder can have a smaller loss accordingly.

With the insulating film formed on the surface of the first powder 701, the withstand voltage of the dust core can improve, and a highly reliable dust core can be obtained.

Table 2 summarizes Second Embodiment, along with the Third and Fourth Embodiments described below.

TABLE 2

| | | Second Embodiment | Third Embodiment | Fourth Embodiment |
|---|---|---|---|---|
| Particles | Pulverized | First powder 501: | First powder 701: | Second powder 702: |
| | powder | 30 weight % or less | 30 weight % or less | 70 weight % or more |
| | | of pulverized | | |
| | | powder | | |
| | | Second powder 502: | | |
| | | 70 weight % or more | | |
| | | of pulverized | | |
| | | powder | | |
| | Spherical | D50%: 9 μm or less | 32 μm or less | More than 32 μm |
| | powder | 1 to 30 volume % of | 70 weight % or more | 30 weight % or less |
| | | dust core | | |

| | | | |
|---|---|---|---|
| Characteristics | Improved | Reduced loss | Improved withstand |
| (Effects) | saturation flux | | voltage |
| | density | | |
| | Improved magnetic | | |
| | permeability | | |

### Third Embodiment

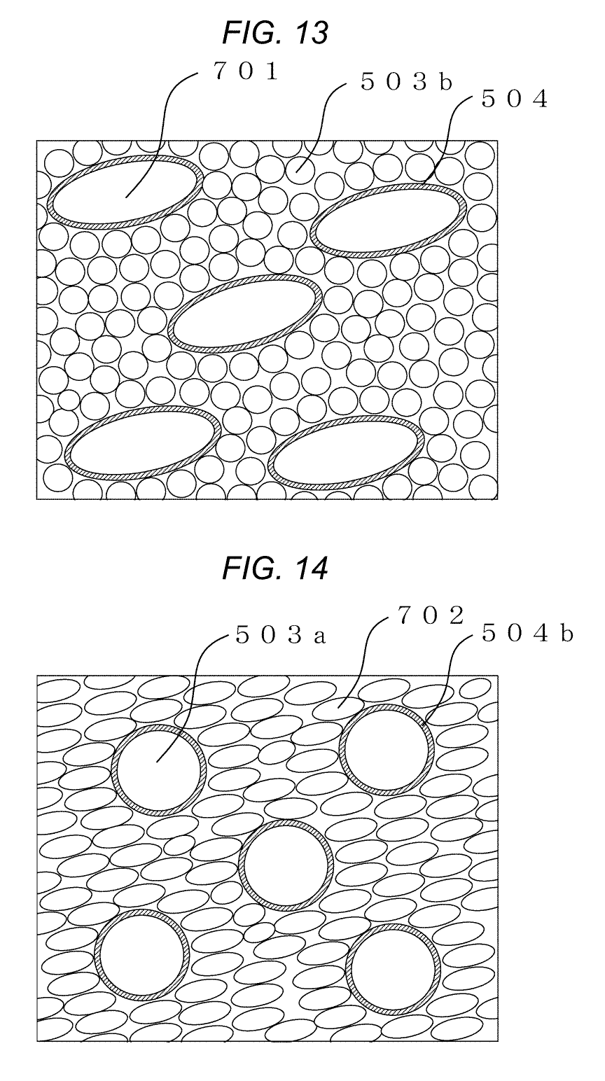

FIG. 13 shows across section of a dust core using a soft magnetic powder as a mixture of a pulverized powder and a second spherical powder 503b according to Third Embodiment of the present disclosure. In FIG. 13, the same elements and configurations already described in FIG. 8 are given the same reference numerals, and explanations thereof are omitted. Anything that is not described in Third Embodiment is the same as in Second Embodiment.

The first powder 701 is the same pulverized powder described in Second Embodiment. The dust core also includes a second spherical powder 503b. The first powder 701 is a pulverized powder having a particle size of more than 32 μm, and is 30 weight % or less of the total soft magnetic powder. The second spherical powder 503b is a spherical powder having a particle size of 32 μm or less, and occupies 70 weight % or more of the total soft magnetic powder. Formed on the surface of the first powder 701 is an insulating film 504 of high electrical resistance. The insulating film 504 is formed by using the same methods described in Second Embodiment.

In Third Embodiment, the pulverized powder of Second Embodiment is sieved to remove a pulverized powder having a particle size of 32 μm or less. The first powder 701, which is a pulverized powder having a particle size of more than 32 μm, is mixed with the second spherical powder 503b having a particle size of 32 μm or less to produce a dust core.

For the production of the second spherical powder 503b, an amorphous-phase powder is produced by using a method such as gas atomization, and water atomization. For example, the Fe—Si—Cr—B (particle size 5 μm) available from Epson Atmix Corporation is used.

### Effects

The pulverized powder (second powder 702) having a particle size of 32 μm or less is produced by cleaving the powder 602, and the particle has a high oxygen content. This increases the coercive force, and the loss increases in the product dust core. To avoid this, the pulverized powder (second powder 702) having a particle size of 32 μm or less is removed by sieving, and the first powder 701 having a particle size of more than 32 μm is mixed with the second spherical powder 503b having a particle size of smaller than 32 μm to produce a dust core. The second spherical powder 503b is produced in the atmosphere by atomization, and the particle surface is only naturally oxidized. The particle therefore has a low oxygen content, and the coercive force is small, making it possible to reduce the loss in the product dust core.

By mixing the second spherical powder 503b having a particle-size cumulative distribution D50% of 9 μm or less as in Second Embodiment, the porosity of the dust core can decrease, and the fraction of the soft magnetic powder as a mixture of the pulverized powder and the spherical powder per unit volume increases, making it possible to improve the soft magnetic characteristics of the dust core, including saturation flux density, and magnetic permeability.

With the insulating film 504 formed on the surface of the first powder 701 having a particle size of more than 32 μm, the withstand voltage of the dust core can improve, and a highly reliable dust core can be obtained.

### Fourth Embodiment

FIG. 14 shows a cross section of a dust core using a soft magnetic powder as a mixture of a pulverized powder and a first spherical powder 503a according to Fourth Embodiment of the present disclosure. In FIG. 14, the same elements and configurations already described in FIG. 8 are given the same reference numerals, and explanations thereof are omitted. Anything that is not described in Fourth Embodiment is the same as in Second Embodiment.

The second powder 702 is the same pulverized powder described in Second Embodiment. The dust core also includes a first spherical powder 503a. The second powder 702 is a pulverized powder having a particle size of 32 μm or less, and is 70 weight % or more of the total soft magnetic powder. The first spherical powder 503a is a spherical powder having a particle size of more than 32 μm, and occupies 30 weight % or less of the total soft magnetic powder. Formed on the surface of the first spherical powder 503a is an insulating film 504b of high electrical resistance. The insulating film is formed by using the same methods described in Second Embodiment.

In Fourth Embodiment, the pulverized powder of Second Embodiment is sieved to remove a first powder 701 having a particle size of more than 32 μm. The first spherical powder 503a, which has a particle size of more than 32 μm, is mixed with the second powder 702, which is a pulverized powder having a particle size of 32 or less, to produce a dust core.

For the production of the spherical powder, an amorphous-phase powder is produced by using a method such as gas atomization, and water atomization. For example, the Fe—Si—Cr—B (particle size 25 μm) available from Epson Atmix Corporation is used.

### Effects

The first powder 701 used in Second and Third Embodiments is produced by cleaving, and the cleaving leaves a pulverization mark on the particle surface. The pulverization mark has a risk of breaking the insulating film, and, in this case, the withstand voltage decreases.

To avoid this, the first powder 701 is removed by sieving, and the second powder 702 having a particle size of 32 μm or less is mixed with the first spherical powder 503a having a particle size of more than 32 μm to produce a dust core. The first spherical powder 503a is produced in the atmosphere by atomization. The powder is therefore spherical, and does not have the pulverization mark seen in the pulverized powder. There accordingly will be no breaking of the insulating film, and the withstand voltage does not decrease.

By mixing the second spherical powder 503b having a particle-size cumulative distribution D50% of 32 μm or less, the porosity of the dust core can decrease, and the fraction of the soft magnetic powder as a mixture of the pulverized powder and the spherical powder per unit volume increases, making it possible to improve the soft magnetic characteristics of the dust core, including saturation flux density, and magnetic permeability.

Because the powder having a particle size of 32 μm or less uses the pulverized powder (second powder 702), the shape is flat, and the porosity is smaller than when the powder is spherical shape. This can improve the magnetic permeability of the dust core.

With the insulating film formed on the surface of the first spherical powder 503a having a particle size of more than 32 μm, the withstand voltage of the dust core can improve, and a highly reliable dust core can be obtained.

### Final Note

The soft magnetic powder constituting the dust core may be any material, for example, a metal, an alloy, a silicon steel sheet, an amorphous alloy, and a nanocrystalline alloy, provided that it shows soft magnetic properties.

The soft magnetic pulverized powder and the spherical powder constituting the dust core may be any material, for example, a metal, an alloy, a silicon steel sheet, an amorphous alloy, and a nanocrystalline alloy, provided that it shows soft magnetic properties.

The soft magnetic pulverized powder and the spherical powder constituting the dust core may be the same material or different materials.

The following dust cores containing the powder of the soft magnetic composition are more effective than the dust core of Comparative Example.

### Dust Core 1

A dust core comprising a powder of a soft magnetic composition, wherein the powder has a maximum roundness of 0.5 or more, and a mean roundness of 0.2 or more.

### Dust Core 2

The dust core according to Dust Core 1, wherein the powder has a maximum length with a maximum value of 50 μm or more and 100 μm or less, a minimum value of 5 μm or less, and a mean value of 5 μm or more and 9 μm or less.

### Dust Core 3

The dust core according to Dust Core 1 or 2, wherein the powder includes a first powder that has a particle size of more than 32 μm, and that is 30 weight % or less of the powder.

Dust Core 4

The dust core according to any one of Dust Cores 1 to 3, wherein the powder includes a second powder that has a particle size of 32 μm or less, and that is 70 weight % or more of the powder.

### Dust Core 5

The dust core according to any one of Dust Cores 1 to 4, wherein the first powder has a total oxygen content of 0.8 weight % or less.

### Dust Core 6

The dust core according to any one of Dust Cores 1 to 5, wherein the second powder has a total oxygen content of 1.7 weight % or less.

### Dust Core 7

The dust core according to any one of Dust Cores 1 to 6, which has a porosity of 30% or less.

### Dust Core 8

The dust core according to any one of Dust Cores 1 to 7, wherein the powder has a particle size d50% of more than 10.7 μm.

### Dust Core 9

A dust core comprising a powder of a soft magnetic composition, wherein the powder includes a pulverized powder and a spherical powder, the pulverized powder having a maximum roundness of 0.5 or more, and a mean roundness of 0.2 or more, the spherical powder having a maximum roundness of 0.9 or more, and a mean roundness of 0.5 or more.

### Dust Core 10

The dust core according to Dust Core 9, wherein the pulverized powder has a maximum length with a maximum value of 50 μm or more and 100 μm or less, a minimum value of 5 μm or less, and a mean value of 5 μm or more and 9 μm or less.

### Dust Core 11

The dust core according to Dust Core 9 or 10, wherein the pulverized powder includes a first powder that has a particle size of more than 32 and that is 30 weight % or less of the pulverized powder.

### Dust Core 12

The dust core according to any one of Dust Cores 9 to 11, wherein the pulverized powder includes a second powder that has a particle size of 32 μm or less, and that is 70 weight % or more of the pulverized powder.

### Dust Core 13

The dust core according to Dust Core 11 or 12, wherein the first powder has a total oxygen content of 0.8 weight % or less.

### Dust Core 14

The dust core according to Dust Core 12 or 13, wherein the second powder has a total oxygen content of 1.7 weight % or less.

### Dust Core 15

The dust core according to any one of Dust Cores 11 to 14, wherein the first powder has a surface with an insulating film of 10 nm or more.

### Dust Core 16

The dust core according to any one of Dust Cores 9, in which a second powder that has a particle size of 32 μm or less is absent, and which includes a first powder that has a particle size of more than 32 μm and the spherical powder, the spherical powder having a particle size of 32 μm or less.

### Dust Core 17

The dust core according to Dust Core 9, in which a first powder that has a particle size of more than 32 μm is absent, and which includes a second powder that has a particle size of 32 μm or less and the spherical powder, the spherical powder having a particle size of more than 32 μm.

### Dust Core 18

The dust core according to any one of Dust Cores 9 to 17, wherein the spherical powder has a particle-size cumulative distribution D50% of 9 μm or less.

The dust cores of the embodiments have inductor applications such as in choke coils, reactors, and transformers. The dust cores also have use in motors.

What is claimed is:

1. A dust core comprising a powder of a soft magnetic composition, wherein the powder has a maximum roundness of 0.5 or more, and a mean roundness of 0.2 or more.

2. The dust core according to claim 1, wherein the powder has a maximum length with a maximum value of 50 μm or more and 100 μm or less, a minimum value of 5 μm or less, and a mean value of 5 μm or more and 9 μm or less.

3. The dust core according to claim 1, wherein the powder includes a first powder that has a particle size of more than 32 μm, and that is 30 weight % or less of the powder.

4. The dust core according to claim 1, wherein the powder includes a second powder that has a particle size of 32 μm or less, and that is 70 weight % or more of the powder.

5. The dust core according to claim 1, wherein the powder includes a first powder that has a total oxygen content of 0.8 weight % or less.

6. The dust core according to claim 1, wherein the powder includes a second powder that has a total oxygen content of 1.7 weight % or less.

7. The dust core according to claim 1, which has a porosity of 30% or less.

8. The dust core according to claim 1, wherein the powder has a particle size d50% of more than 10.7 μm.

9. A dust core comprising a powder of a soft magnetic composition, wherein the powder includes a pulverized powder and a spherical powder, the pulverized powder having a maximum roundness of 0.5 or more, and a mean roundness of 0.2 or more, the spherical powder having a maximum roundness of 0.9 or more, and a mean roundness of 0.5 or more.

10. The dust core according to claim 9, wherein the pulverized powder has a maximum length with a maximum value of 50 μm or more and 100 μm or less, a minimum value of 5 μm or less, and a mean value of 5 μm or more and 9 μm or less.

11. The dust core according to claim 9, wherein the pulverized powder includes a first powder that has a particle size of more than 32 μm, and that is 30 weight % or less of the pulverized powder.

12. The dust core according to claim 9, wherein the pulverized powder includes a second powder that has a particle size of 32 μm or less, and that is 70 weight % or more of the pulverized powder.

13. The dust core according to claim 11, wherein the first powder has a total oxygen content of 0.8 weight % or less.

14. The dust core according to claim 12, wherein the second powder has a total oxygen content of 1.7 weight % or less.

15. The dust core according to claim 11, wherein the first powder has a surface with an insulating film of 10 nm or more.

16. The dust core according to claim 9, in which a second powder that has a particle size of 32 μm or less is absent, and which includes a first powder that has a particle size of more than 32 μm and the spherical powder, the spherical powder having a particle size of 32 μm or less.

17. The dust core according to claim 9, in which a first powder that has a particle size of more than 32 μm is absent, and which includes a second powder that has a particle size of 32 μm or less and the spherical powder, the spherical powder having a particle size of more than 32 μm.

18. The dust core according to claim 9, wherein the spherical powder has a particle-size cumulative distribution D50% of 9 μm or less.
